(19) United States
(12) Patent Application Publication
(10) Pub. No.: US 2022/0020010 A1
(43) Pub. Date: Jan. 20, 2022

(54) DECENTRALIZED ELECTRONIC CONTRACT ATTESTATION PLATFORM

(71) Applicant: Jiangsu Aowei Holdings Co., Ltd., Nanjing (CN)

(72) Inventor: Jie BAI, Nanjing (CN)

(73) Assignee: Jiangsu Aowei Holdings Co., Ltd., Nanjing (CN)

(21) Appl. No.: 17/379,153

(22) Filed: Jul. 19, 2021

(30) Foreign Application Priority Data
Jul. 20, 2020 (CN) 202010699162.4
Sep. 9, 2020 (CN) 202010938085.3

(51) Int. Cl. G06Q 20/38; G06Q 20/40; H04L 9/08; H04L 9/32

(52) U.S. Cl. CPC G06Q 20/3823; G06Q 20/3829; G06Q 20/3825; G06Q 20/3827; G06Q 20/401; H04L 2209/56; H04L 9/0825; H04L 9/3297; H04L 9/3236; G06Q 2220/00; H04L 2209/38; H04L 9/0894

(57) ABSTRACT

This application provides a decentralized electronic contract attestation platform, where the attestation platform is connected to a user client through a deposit thread and a forensic thread that are established with an existing electronic contract platform; the attestation platform includes a deposit unit and a forensic unit; the deposit unit is configured to verify transaction data of a deposit transaction initiated by the user client, and if the verification is passed, upload and store the transaction data on a chain; and the forensic unit is configured to obtain, based on a forensic request sent by the user client, transaction data that corresponds to the forensic request and is stored in a blockchain, and send the transaction data to the user client. According to this application, deposit and forensic operations of an electronic contract are correspondingly completed by using the established deposit thread and forensic thread. Managing the transaction data of a user by using the decentralized electronic contract attestation platform avoids a possibility that an existing platform may arbitrarily tamper with the transaction data of the deposit transaction of the user, and improves security of transaction information of the user.

This application claims the priority to the Chinese Application No. 202010699162.4, filed with the Chinese Patent Office on Jul. 20, 2020 and entitled “DECENTRALIZED ELECTRONIC CONTRACT ATTESTATION PLATFORM”, which is incorporated herein by references in its entirety.

### FIELD OF THE INVENTION

This application relates to the technical field of digital-asset deposit technology, and in particular, to a decentralized electronic contract attestation platform.

### BACKGROUND OF THE INVENTION

An electronic contract platform provides a user with a series of services such as identity authentication, certificate authentication, contract services, signing services, evidence deposit, and judicial proof. After registering a platform account and logging onto the platform, the user may complete signature, renewal, termination, inspection, and other follow-up related lifecycle processes of a standard electronic contract.

However, an existing electronic contract platform is centralized both in terms of architecture design and implementation, and data stored in the platform may be tampered with and forged. As a result, user registration information, personal identification information, enterprise real-name information, digital certificate issuance information, signing intention deposit information, contract signing information, system log information, and the like that are stored in the platform are easily leaked or lost. In this case, not only heavy losses are caused to interests of the user, but difficulty in platform management is also increased.

### SUMMARY OF THE INVENTION

This application provides a decentralized electronic contract attestation platform, to resolve a problem that in conventional deposit and forensic processes of an electronic contract, data has low security and is easy to be tampered with.

This application provides a decentralized electronic contract attestation platform, where the attestation platform is connected to a user client through a deposit thread and a forensic thread that are established with an existing electronic contract platform;

the attestation platform includes a deposit unit and a forensic unit;

the deposit unit is configured to verify transaction data of a deposit transaction initiated by the user client, and if the verification is passed, upload and store the transaction data on a chain; and

the forensic unit is configured to obtain, based on a forensic request sent by the user client, transaction data that corresponds to the forensic request and is stored in a blockchain, and send the transaction data to the user client.

This application provides a decentralized electronic contract attestation platform, to correspondingly complete deposit and forensic operations of an electronic contract by using the established deposit thread and forensic thread. According to this application, managing the transaction data of a user by using the decentralized electronic contract attestation platform avoids a possibility that an existing platform may arbitrarily tamper with the transaction data of the deposit transaction of the user. The transaction data is encrypted and then is uploaded and stored on a chain or is escrowed by nodes on the blockchain or a federated chain, thereby improving security of transaction information of the user.

### BRIEF DESCRIPTION OF THE DRAWINGS

To more clearly describe the technical solutions of this application, the accompanying drawings to be used in the embodiments are briefly illustrated below. Obviously, persons of ordinary skills in the art can also derive other accompanying drawings according to these accompanying drawings without creative efforts.

FIG. 1 is a schematic structural diagram of a decentralized electronic contract attestation platform according to this application;

FIG. 2 is a view of an application scenario of a method according to this application;

FIG. 3 is a schematic diagram of basic components of a decentralized electronic contract attestation platform according to this application;

FIG. 4 is a schematic diagram of downloading deposit data of a deposit transaction by using a data index; and

FIG. 5 is a schematic diagram of basic components of a decentralized electronic contract attestation platform according to another embodiment of this application.

### DETAILED DESCRIPTION OF THE EMBODIMENTS

Embodiments are described below in detail, and examples thereof are shown in the accompanying drawings. When the descriptions below relate to the accompanying drawings, unless otherwise stated, same numbers in different accompanying drawings indicate same or similar elements. Implementations described in the following embodiments do not represent all implementations consistent with this application. These implementations are merely examples of a system and a method that are described in detail in the claims and in accordance with some aspects of this application.

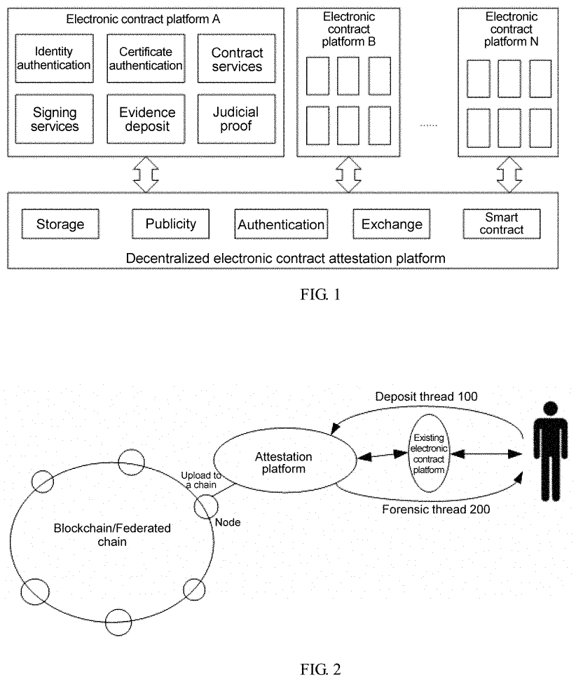

In a technical solution provided in this application, a decentralized electronic contract attestation platform refers to an application model with a decentralized application architecture. As shown in FIG. 1, in practical application, in addition to data storage, publicity, authentication, exchange, and a smart contract, the decentralized electronic contract attestation platform may also complete functions such as data exchange with another existing electronic contract platform. Meanwhile, the decentralized electronic contract attestation platform in this application may exchange data with a plurality of existing electronic contract platforms, to satisfy a plurality of actual requirements.

To reflect characteristics of decentralization, the decentralized electronic contract attestation platform in this application is correspondingly disposed on a node on a blockchain, or is connected to a node on the blockchain. The decentralized electronic contract attestation platform performs operations such as data uploading and retrieval and transactions between nodes.

FIG. 2 is a view of an application scenario of a method according to this application. In an embodiment of this application, a decentralized electronic contract attestation platform (an attestation platform for short) is disposed on a node on a blockchain. If a user needs to use the decentralized electronic contract attestation platform, or needs to complete deposit, forensic, and other operations in the attestation platform, a request may be sent by using an existing electronic contract platform connected to the decentralized electronic contract attestation platform. According to different received requests, the decentralized electronic contract attestation platform correspondingly performs different operations, such as processing data, uploading data to the blockchain, or obtaining data from the blockchain, by using different threads. Different from the existing electronic contract platform, the decentralized electronic contract attestation platform involves all data of the user, and all of the data needs to be uploaded to the blockchain after being processed by the platform, to synchronize all nodes in the blockchain.

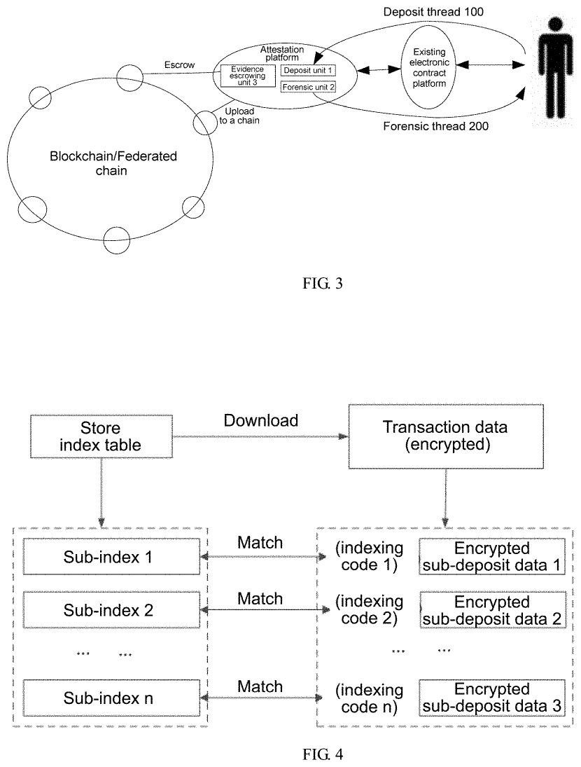

FIG. 3 is a schematic diagram of basic components of a decentralized electronic contract attestation platform according to this application.

It may be learned from FIG. 3 that the attestation platform is connected to a user client through a deposit thread 100 and a forensic thread 200 that are established with an existing electronic contract platform;

the attestation platform includes a deposit unit 1 and a forensic unit 2;

the deposit unit 1 is configured to verify transaction data of a deposit transaction initiated by the user client, and if the verification is passed, upload and store the transaction data on a chain; and

the forensic unit 2 is configured to obtain, based on a forensic request sent by the user client, transaction data that corresponds to the forensic request and is stored in a blockchain, and send the transaction data to the user client.

In this embodiment, the attestation platform may complete a deposit process by using the deposit unit. Specifically, the deposit thread 100 is configured to perform the following steps:

a verification step: verifying legitimacy, integrity, and validity of the received transaction data by using a public key of a user and a public key of the existing electronic contract platform;

a smart contract invoking step: invoking a smart contract, to transmit the transaction data into the smart contract, and execute the smart contract, to obtain a smart contract execution result;

a block packing step: generating a data block for the smart contract execution result;

a step of uploading and storing on a chain: uploading and storing the transaction data, the smart contract execution result, and the data block on a chain;

a transaction hash operation step: performing a hash operation on a contract transaction, to obtain a transaction hash value, where an initiator of the contract transaction is the user, a receiver thereof is a corresponding address of the smart contract, and the contract transaction is commonly signed by a private key of the user and a private key of the existing electronic contract platform;

a step of transmitting data back: transmitting the transaction data, the smart contract execution result, the contract transaction, the data block, and the transaction hash value back to the existing electronic contract platform; and

a step of continuing to transmit the data: transmitting the transaction data, the smart contract execution result, the contract transaction, the data block, and the transaction hash value to an attestation platform corresponding to other nodes on the blockchain.

Further, in a feasible embodiment, a preset number of deposit nodes is set in the smart contract; and

the deposit thread 100 is further configured to:

decide whether a number of attestation platforms that complete the step of uploading and storing on a chain exceeds the preset number of deposit nodes; and

when the number of attestation platforms that complete the step of uploading and storing on a chain exceeds the preset number of deposit nodes, complete the execution of the smart contract, and no longer perform the step of transmitting the transaction data, the smart contract execution result, the contract transaction, the data block, and the transaction hash value to the attestation platform corresponding to other nodes on the blockchain. When generation time of the data block exceeds preset deposit time, meaning that there are sufficient number of blocks after the sequence number of the data block on the attestation platform. In other words, the data block on the attestation platform deposits data related to the electronic contract.

In addition, the deposit thread 100 may be further configured to implement other functions, for example, may set the preset deposit time in the smart contract; in other words, to decide whether the generation time of the data block meets the preset deposit time. When the generation time of the data block exceeds the preset deposit time, it is considered that the execution of the smart contract is completed, and a deposit procedure of the electronic contract ends. In this case, the step of continuing to transmit the data may be stopped, thereby saving system resources.

It should be noted that both the foregoing preset number of deposit nodes and the preset deposit time may be set in advance according to actual requirements. The attestation platform requires sufficient number of nodes to deposit the electronic contract, thus being able to ensure validity and credibility of deposit. A data block may be regenerated at a position of each node, and a time stamp may be added to mark time attribute of the data block. By setting the preset number of deposit nodes and the preset deposit time in the smart contract, validity and credibility of storing the electronic contract on the attestation platform may be ensured, being more efficient.

The foregoing steps are of a method of depositing by means of a smart contract. In another embodiment, deposit may be performed by means of a transaction. In this case, the deposit thread 100 is configured to perform the following steps:

a verification step: verifying legitimacy, integrity, and validity of the received transaction data by using a public key of a user and a public key of the existing electronic contract platform;

a data block generating step: generating a data block for the transaction data and the deposit transaction, and stamping the data block with a time stamp;

a step of uploading and storing on a chain: uploading and storing the transaction data, the deposit transaction, and the data block on a chain;

a transaction hash operation step: performing a hash operation on the deposit transaction, to obtain a transaction hash value;

a step of transmitting data back: transmitting the transaction data, the deposit transaction, the data block, and the transaction hash value back to the existing electronic contract platform; and

a step of continuing to transmit the data: transmitting the transaction data, the deposit transaction, the data block, and the transaction hash value to an attestation platform corresponding to other nodes on the blockchain.

In this embodiment, the attestation platform may complete a forensic process by using the forensic unit. Specifically, the forensic thread 200 is configured to perform the following:

S11: Obtain a forensic request for an electronic contract which is initiated by an existing electronic contract platform. First, a forensic request is initiated by using the existing electronic contract platform. For example, there may be a forensic request button provided on the existing electronic contract platform, and when the button is pressed, the existing electronic contract platform may trigger a forensic request to the attestation platform, that is, a request for querying and retrieving the electronic contract. The attestation platform obtains the forensic request.

S12: Decide whether deposit information corresponding to the electronic contract is stored in the attestation platform, and if yes, obtain a transaction hash value corresponding to the deposit information.

To perform forensic on an electronic contract in the attestation platform, it is required to confirm whether the electronic contract is deposited in the platform, that is, to query whether deposit information of the electronic contract exists in the attestation platform. At this time, if the deposit information exists, it is indicated that the electronic contract has been stored in the attestation platform in advance; and after the deposit information of the electronic contract is queried, a next step may be performed. If the deposit information does not exist, it is indicated that the electronic contract has not been stored in the attestation platform in advance; and the deposit information cannot be queried, thus query is ended immediately. Whether there is a corresponding deposit transaction in the attestation platform may be decided based on the transaction hash value corresponding to the deposit information.

S13: Decide, based on the transaction hash value, whether the deposit transaction exists in the attestation platform, and if the deposit transaction exists, obtain transaction data of the deposit transaction and a data index of the transaction data, the transaction data being encrypted.

For example, there may be a query box in the attestation platform, and whether there is a deposit transaction of an electronic contract to be queried may be queried by inputting a keyword or a corresponding transaction hash value. If the deposit transaction exists, a next step may be performed. If the deposit transaction does not exist, query is ended immediately. Because the electronic contract is deposited in the attestation platform in an encrypted form, deposited transaction data obtained at this time is encrypted. Data query efficiency may be improved by obtaining the data index, and particular information in a database table may be quickly accessed by using the data index.

S14: Verify validity of a private-key signature of the transaction data, and if the private-key signature is valid, decrypt the transaction data to generate decrypted transaction information.

A specific encryption and decryption method for decrypting the transaction data may be preset; this is not specifically limited in this application. Decrypted transaction information is generated after decryption. It should be noted that before this step, validity of a private-key signature of the deposit transaction data may be verified. In other words, whether the deposit transaction data obtained in the foregoing step may be decrypted is verified by using private key information of the user or the electronic contract platform. If the private-key signature of the deposit transaction data is valid, a next step may be performed. If the private-key signature of the deposit transaction data is invalid, query is ended.

The private-key signature of the deposit transaction data may include a digital signature. A validity verification method of the digital signature is taken as an example. For example, if a sender sends a digitally signed file to the other party, a specific verification process may be that: a digest is generated for a file to be sent by the sender by using a cryptographic hash function (such as MD5, SHA, or SM3); and the sender re-encrypts the digest by using a private key thereof, and after a digital signature is formed, sends original digest and the encrypted digest to the other party at the same time. The other party verifies the digest by using a public key of the sender, obtains the digest generated by the sender, and encrypts the received file with SHA encoding to generate another digest. The decrypted digest is compared with the digest that is generated by re-encrypting the received file by the receiver. If the two are consistent, it is indicated that information is not destroyed or tampered with during a transmission process, and the data is integral. In this case, it is verified that the digital signature is valid.

S15: Download data of the deposit transaction by using the data index, and splice to obtain forensic data. Because the electronic contract is deposited in the attestation platform in an encrypted form, the deposit transaction data obtained at this time is encrypted. The electronic contract may be discretized data when deposited on the platform. After the downloading is completed, the discretized data is spliced, and transaction data is obtained after the splicing. Because the discretized data is encrypted, the transaction data formed after the splicing is also encrypted, and needs to be decrypted later.

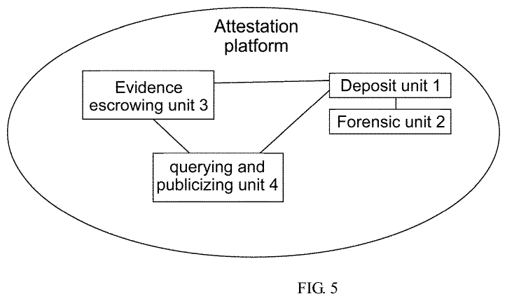

For a specific process of downloading deposit data of the deposit transaction by using the data index, reference is made to FIG. 4. FIG. 4 is a schematic diagram of downloading deposit data of a deposit transaction by using a data index. It may be learned from FIG. 4 that the data index may be split into a plurality of sub-indexes, that is, may include a plurality of sub-indexes, such as sub-index 1, sub-index 2, . . . , and sub-index n. The deposit data of the deposit transaction may include a plurality of pieces of discretized encrypted sub-deposit data, and each piece of the encrypted sub-deposit data contains an indexing code. For example, an indexing code of encrypted sub-deposit data 1 is indexing code 1, and an indexing code of encrypted sub-deposit data n is indexing code n, where the indexing code is unique. In other words, there is no duplication in the plurality of indexing codes. In the process of downloading the deposit data by using the data index, the plurality of sub-indexes of the data index are respectively matched with the plurality of indexing codes of the deposit data. If the sub-index and the indexing code are successfully matched, it is indicated that there may be encrypted sub-deposit data that matches with the sub-index. For example, upon comparison, it is found that the sub-index 1 matches with the indexing code 1, it is indicated that the encrypted sub-deposit data 1 may be downloaded by using the sub-index 1. In other words, after the successful matching, the encrypted sub-deposit data corresponding to the indexing code that matches with the sub-index is downloaded. After all indexing codes matching with the sub-indexes are found, all successfully matched encrypted sub-deposit data is downloaded. These encrypted sub-deposit data forms the deposit data of the deposit transaction.

It should be noted that to obtain the transaction data, the plurality pieces of encrypted sub-deposit data that forms the deposit data further needs to be spliced. Splicing herein does not mean a simple combination, but is processing the data according to certain rules. A specific processing rule may be established in advance.

Further, the data of the deposit transaction downloaded by using the data index includes several pieces of discretized encrypted sub-deposit data, each piece of the encrypted sub-deposit data contains an indexing code, and the indexing code is unique.

S16: Decrypt the forensic data by using a valid private key, to generate decrypted forensic data.

S17: Verify the decrypted forensic data, and if the verification is passed, generate a forensic report.

To ensure credibility of information and data, the validity, legitimacy, and integrity of the decrypted forensic data need to be verified. For example, data integrity may be verified by using a digital signature. A method for verifying the validity, the legitimacy, and the integrity is not specifically limited in this application.

A corresponding forensic report may be generated based on a verification result. For example, after the validity, the legitimacy, and the integrity of the decrypted transaction information and the decrypted forensic data pass the verifications, it is indicated that the electronic contract obtained through forensic does come from a blockchain digital deposit platform, and is not damaged in deposit and forensic processes with integral and valid data, thereby ensuring forensic credibility. For a case in which the verification is passed, the forensic report may contain relevant statements indicating that the verification is passed. If the verification is not passed, there may be descriptions indicating that the verification is not passed in the forensic report. A forensic report is generated after validity, legitimacy, and integrity of the decrypted transaction data are verified, and forensic is ended. Till this time, forensic of the electronic contract is completed.

The foregoing forensic thread is configured to implement a forensic method by means of a transaction. Correspondingly, forensic may alternatively be performed by means of a smart contract, and a corresponding method is as follows.

S21: Obtain a forensic request for an electronic contract which is initiated by the existing electronic contract platform.

When a user wants to query and retrieve an electronic contract in the attestation platform, first, a forensic request is initiated by using the existing electronic contract platform. For example, there may be a forensic request button in the existing electronic contract platform, and when the button is pressed, the existing electronic contract platform may trigger a forensic request to the attestation platform, that is, a request for querying and retrieving the electronic contract. The attestation platform obtains the forensic request.

S22: Decide whether deposit information corresponding to the electronic contract is stored in the attestation platform, and if yes, construct a forensic transaction, and invoke a smart contract to initiate the forensic transaction.

To perform forensic on an electronic contract in the attestation platform, it is required to confirm whether the electronic contract is deposited in the attestation platform, that is, to query whether deposit information of the electronic contract exists in the attestation platform. It is decided whether the deposit information corresponding to the electronic contract is stored in the attestation platform. If the deposit information exists, it is indicated that the electronic contract has been stored in the attestation platform in advance; and after the deposit information of the electronic contract is queried, a next step may be performed. If the deposit information does not exist, it is indicated that the electronic contract has not stored in the attestation platform in advance, and after the deposit information of the electronic contract is not queried, the query is ended immediately.

S23: Verify the forensic transaction and generate an execution result based on the smart contract. For the verification of the forensic transaction, a specific verification scheme is not specifically limited in this application. After the verification, the smart contract is executed, and an execution result is generated at the same time.

For the verification of the forensic transaction, the specific verification scheme is not specifically limited in this application. If the forensic transaction passes the verification, the smart contract is executed at a next step, and an execution result is generated at the same time. If the forensic transaction does not pass the verification, for example, during the verification, it is found that the forensic transaction currently being verified is not the forensic transaction constructed in the foregoing step, it is possible that relevant information may be missed or damaged in a certain process. At this time, relevant information of the forensic transaction does not correspond to relevant information of the deposit transaction in the blockchain digital deposit platform. In this case, a verification result is that the verification is not passed, and the smart contract cannot be executed at the next step. The next step can be performed only when the forensic transaction passes the verification. In other words, the smart contract can be executed when the forensic transaction pass the verification, to generate an execution result. To ensure the execution of a forensic operation, a forensic transaction needs to be reconstructed at this time. After the construction is completed, the reconstructed forensic transaction is re-initiated to the smart contract in the blockchain digital deposit platform, and is verified, until the forensic transaction passes the verification.

S24: Obtain the transaction data of the deposit transaction and a data index of the transaction data based on the execution result. Deposit transaction data of the deposit transaction and a data index of the deposit transaction data are obtained based on the execution result. Because the electronic contract is deposited in the blockchain digital deposit platform in an encrypted form, the deposit transaction data obtained at this time is encrypted. Data query efficiency may be accelerated by obtaining the data index, and particular information in a database table may be quickly accessed by using the data index.

S25: Decrypt the transaction data to generate decrypted transaction information. A specific encryption and decryption method for decrypting deposit transaction information may be set in advance; this is not specifically limited in this application. Decrypted transaction information is generated after the decryption. It should be noted that before S7, validity of a private-key signature of deposit transaction information may be verified. In other words, whether the deposit transaction information may be decrypted is verified by using private key information of the user or the electronic contract platform. If a private-key signature of the deposit transaction information is valid, a next step may be performed. If the private-key signature of the deposit transaction information is invalid, query is ended.

S26: Download data of the deposit transaction by using the data index, and splice to obtain forensic data. This step is the same as the step of S15, and for specific description, reference may be made to the foregoing description. Details are not described herein again.

S27: Decrypt the forensic data to generate decrypted forensic data. The deposit transaction information is decrypted if the private-key signature is verified to be valid. A specific encryption and decryption method may be set in advance; this is not specifically limited in this application. Decrypted transaction information is generated after the decryption.

S28: Verify the decrypted forensic data, and if the verification is passed, generate a forensic report.

Steps of the foregoing method that is based on a smart contract are similar to those of the foregoing method that is based on a transaction. For same steps, reference may be made to each other, and details are not described herein again.

Further, in view of FIG. 3, in a feasible embodiment, the attestation platform further includes:

an evidence escrowing unit 3, configured to perform the following steps:

an escrowing transaction generating step: recording a process of uploading and storing the transaction data generated based on the deposit transaction on a chain as an electronic evidence escrowing transaction, where the transaction data includes an electronic evidence, a digital digest, an evidence signature, and a time stamp. It should be noted that before performing escrowing, usually an encryption step is also needed to be performed on escrowed data to encrypt the electronic evidence, the digital digest, the evidence signature, and the time stamp. After the encryption, the encrypted data is sent to the attestation platform, thereby further enhancing data security during a data transmission process. The encryption scheme may use a symmetric key, and user information of the electronic evidence may be used as a key for encryption. This is not specifically limited in this application.

Correspondingly, the evidence escrowing unit 3 further has a function of decrypting the encrypted data.

an evidence sending step: sending the electronic evidence, the digital digest, the evidence signature, the time stamp, and the electronic evidence escrowing transaction to a blockchain or a blockchain platform, where the blockchain platform packs the received electronic evidence, digital digest, evidence signature, and time stamp and generates a data block, and uploads and stores the data block and the electronic evidence escrowing transaction on a chain.

Further, in view of FIG. 5, in a feasible embodiment, the attestation platform further includes:

a querying and publicizing unit 4, configured to publicize and query deposit data through a website or a public interface.

For similar parts between the embodiments provided in this application, reference may be made to each other. The specific implementations described above are merely some examples under a general concept of this application, and do not constitute any limitation to the protection scope of this application. For a person skilled in the art, any other implementations derived according to the solutions of this application without creative efforts all fall within the protection scope of this application.

What is claimed is:

1. A decentralized electronic contract attestation platform, wherein the attestation platform is connected to a user client through a deposit thread (100) and a forensic thread (200) that are established with an existing electronic contract platform;
the attestation platform comprises a deposit unit (1) and a forensic unit (2);
the deposit unit (1) is configured to verify transaction data of a deposit transaction initiated by the user client, and if the verification is passed, upload and store the transaction data on a chain; and
the forensic unit (2) is configured to obtain, based on a forensic request sent by the user client, transaction data that corresponds to the forensic request and is stored in a blockchain, and send the transaction data to the user client.

2. The decentralized electronic contract attestation platform according to claim 1, wherein the deposit thread (100) is configured to perform the following steps:
verifying legitimacy, integrity, and validity of the received transaction data by using a public key of a user and a public key of the existing electronic contract platform;
invoking a smart contract, to transmit the transaction data into the smart contract, and executing the smart contract, to obtain a smart contract execution result;
generating a data block for the smart contract execution result;
uploading and storing the transaction data, the smart contract execution result, and the data block on a chain;
performing a hash operation on a contract transaction, to obtain a transaction hash value, wherein an initiator of the contract transaction is the user, a receiver thereof is a corresponding address of the smart contract, and the contract transaction is commonly signed by a private key of the user and a private key of the existing electronic contract platform;
transmitting the transaction data, the smart contract execution result, the contract transaction, the data block, and the transaction hash value back to the existing electronic contract platform; and
transmitting the transaction data, the smart contract execution result, the contract transaction, the data block, and the transaction hash value to an attestation platform corresponding to other nodes on the blockchain.

3. The decentralized electronic contract attestation platform according to claim 2, wherein a preset number of deposit nodes is set in the smart contract; and
the deposit thread (100) is further configured to:
decide whether a number of attestation platforms that complete the step of uploading and storing on a chain exceeds the preset number of deposit nodes; and
when the number of attestation platforms that complete the step of uploading and storing on a chain exceeds the preset number of deposit nodes, complete the execution of the smart contract, and no longer perform the step of transmitting the transaction data, the smart contract execution result, the contract transaction, the data block, and the transaction hash value to the attestation platform corresponding to other nodes on the blockchain.

4. The decentralized electronic contract attestation platform according to claim 1, wherein the deposit thread (100) is configured to perform the following steps:
verifying legitimacy, integrity, and validity of the received transaction data by using a public key of a user and a public key of the existing electronic contract platform;
generating a data block for the transaction data and the deposit transaction, and stamping the data block with a time stamp;
uploading and storing the transaction data, the deposit transaction, and the data block on a chain;
performing a hash operation on the deposit transaction, to obtain a transaction hash value;
transmitting the transaction data, the deposit transaction, the data block, and the transaction hash value back to the existing electronic contract platform; and
transmitting the transaction data, the deposit transaction, the data block, and the transaction hash value to an attestation platform corresponding to other nodes on the blockchain.

5. The decentralized electronic contract attestation platform according to claim 1, wherein the forensic thread (200) is configured to perform the following steps:
obtaining a forensic request for an electronic contract which is initiated by the existing electronic contract platform;
deciding whether deposit information corresponding to the electronic contract is stored in the attestation platform, and if yes, obtaining a transaction hash value corresponding to the deposit information;
deciding, based on the transaction hash value, whether the deposit transaction exists in the attestation platform, and if the deposit transaction exists, obtaining transaction data of the deposit transaction and a data index of the transaction data, the transaction data being encrypted;
verifying validity of a private-key signature of the transaction data, and if the private-key signature is valid, decrypting the transaction data to generate decrypted transaction information;
downloading data of the deposit transaction by using the data index, and splicing to obtain forensic data;
decrypting the forensic data by using a valid private key, to generate decrypted forensic data; and
verifying the decrypted forensic data, and generating a forensic report.

6. The decentralized electronic contract attestation platform according to claim 1, wherein the data of the deposit transaction downloaded by using the data index comprises several pieces of discretized encrypted sub-deposit data, each piece of the encrypted sub-deposit data contains an indexing code, and the indexing code is unique.

7. The decentralized electronic contract attestation platform according to claim 1, wherein the forensic thread (200) is configured to perform the following steps:
obtaining a forensic request for an electronic contract which is initiated by the existing electronic contract platform;
deciding whether deposit information corresponding to the electronic contract is stored in the attestation platform, and if yes, constructing a forensic transaction, and invoking a smart contract to initiate the forensic transaction;
verifying the forensic transaction and generating an execution result based on the smart contract;
obtaining the transaction data of the deposit transaction and an data index of the transaction data based on the execution result;
decrypting the transaction data to generate decrypted transaction information;
downloading data of the deposit transaction by using the data index, and splicing to obtain forensic data;
decrypting the forensic data, to generate decrypted forensic data; and
verifying the decrypted forensic data, and if the verification is passed, generating a forensic report.

8. The decentralized electronic contract attestation platform according to any one of claims 2 to 7, wherein the attestation platform further comprises:
an evidence escrowing unit (3), configured to perform the following steps:
an escrowing transaction generating step: recording a process of uploading and storing the transaction data generated based on the deposit transaction on a chain as an electronic evidence escrowing transaction, wherein the transaction data comprises an electronic evidence, a digital digest, an evidence signature, and a time stamp; and
an evidence sending step: sending the electronic evidence, the digital digest, the evidence signature, the time stamp, and the electronic evidence escrowing transaction to a blockchain platform, wherein the blockchain platform packs the received electronic evidence, digital digest, evidence signature, and time stamp and generates a data block, and uploads and stores the data block and the electronic evidence escrowing transaction on a chain.

9. The decentralized electronic contract attestation platform according to claim 8, wherein in the escrowing transaction generating step, the transaction data generated based on the deposit transaction is encrypted before being uploaded and stored on a chain; and
the evidence escrowing unit (3) is further configured to decrypt the received transaction data that is encrypted.

10. The decentralized electronic contract attestation platform according to claim 9, wherein the attestation platform further comprises:
a querying and publicizing unit (4), configured to publicize and query deposit data through a website or a public interface.
